(19) United States
(12) Patent Application Publication
(10) Pub. No.: US 2026/0346684 A1
(43) Pub. Date: Nov. 5, 2026

(54) AIR CONDITIONER UNIT WITH SOFT START

(71) Applicant: Haier US Appliance Solutions, Inc., Wilmington, DE (US)

(72) Inventors: Tyler James Doering, Louisville, KY (US); Richard Dustin Henderson, La Grange, KY (US)

(21) Appl. No.: 19/194,683

(22) Filed: Apr. 30, 2025

(51) Int. Cl. B60H 1/32

(52) U.S. Cl. CPC B60H 1/3226

(57) ABSTRACT

An air conditioner unit for a recreational vehicle includes a housing defining an indoor portion in fluid communication with an interior space and an outdoor portion. An outdoor heat exchanger and an outdoor fan are disposed in the outdoor portion. An indoor heat exchanger and an indoor fan are disposed in the indoor portion. The air conditioner unit also includes a compressor in fluid communication with the outdoor heat exchanger and the indoor heat exchanger to circulate a refrigerant between the outdoor heat exchanger and the indoor heat exchanger. The air conditioner unit further includes a circuit in electrical communication with the compressor and a controller. The controller is configured to determine a status of the circuit and permit or prevent activation of the controller in response to the determined status of the circuit.

### FIELD OF THE INVENTION

The present subject matter relates generally to air conditioners, such as may be used in recreational vehicles, and to soft start systems for air conditioner units.

### BACKGROUND OF THE INVENTION

Air conditioner or air conditioning appliance units are conventionally utilized to adjust the temperature within structures such as dwellings and office buildings. A typical air conditioner or air conditioning appliance includes an indoor portion and an outdoor portion. The indoor portion generally communicates (e.g., exchanges air) with the conditioned space, e.g., within a building or other structure, and the outdoor portion generally communicates (e.g., exchanges air) with the area outside the structure. Generally, a fan may be operable to rotate to motivate air through the indoor portion. Another fan may be operable to rotate to motivate air through the outdoor portion. A sealed refrigerant system including a compressor is generally housed within the air conditioner unit to treat (e.g., cool or heat) air as it is circulated through, for example, the indoor portion of the air conditioner unit, using indoor and outdoor heat exchangers to facilitate heat transfer between the conditioned space and the external environment. One or more control boards are typically provided to direct the operation of various elements of the particular air conditioner unit.

Certain recreational vehicles include an air conditioning system, referred to generally as a recreational vehicle air conditioner (RVAC), for maintaining a comfortable temperature within the passenger compartment (that is, the passenger compartment or a portion thereof may be the conditioned space and the RV may be the structure). The air conditioning units are typically mounted on the roof or another exterior location of the recreational vehicle. For example, the indoor heat exchanger is positioned within an indoor portion of the RVAC and is in fluid communication with the passenger compartment through an opening in the roof. The outdoor heat exchanger is positioned within the outdoor portion and is separated from the indoor heat exchanger by a partition or divider.

When an air conditioner unit is operated, the compressor of the sealed refrigerant system urges refrigerant through the sealed system, such as from a suction side of the compressor to a pressure side of the compressor, e.g., a pressure differential or pressure gradient is formed across the compressor. If the compressor is short-cycled, e.g., started up again shortly after stopping (and especially following an extended run time), the sealed system pressure differential may impair operation of the compressor, such as may impose an undue load on the compressor, potentially increasing wear on the compressor and reducing the useful life of the compressor. Thus, there is a desire in the art to ensure a minimum time elapses between the end of a compressor cycle and the beginning of the next compressor cycle to permit the sealed system pressure to equalize. Accordingly, an improved air conditioner unit would be useful.

### BRIEF DESCRIPTION OF THE INVENTION

Aspects and advantages of the invention will be set forth in part in the following description, or may be apparent from the description, or may be learned through practice of the invention.

In one exemplary aspect of the present disclosure, a recreational vehicle is provided. The recreational vehicle defines a passenger compartment therein. The recreational vehicle includes an air conditioner unit. The an air conditioner unit includes a housing defining an indoor portion and an outdoor portion. The indoor portion of the housing is in fluid communication with the passenger compartment. An outdoor heat exchanger and an outdoor fan are disposed in the outdoor portion. An indoor heat exchanger and an indoor fan are disposed in the indoor portion. The air conditioner unit also includes a compressor in fluid communication with the outdoor heat exchanger and the indoor heat exchanger to circulate a refrigerant between the outdoor heat exchanger and the indoor heat exchanger, a circuit in electrical communication with the compressor, and a controller coupled to the circuit. The controller is configured to determine a status of the circuit and permit or prevent activation of the compressor in response to the determined status of the circuit.

In another exemplary aspect of the present disclosure, an air conditioner unit for a recreational vehicle is provided. The air conditioner unit includes a housing defining an indoor portion in fluid communication with an interior space and an outdoor portion. An outdoor heat exchanger and an outdoor fan are disposed in the outdoor portion. An indoor heat exchanger and an indoor fan are disposed in the indoor portion. The air conditioner unit also includes a compressor in fluid communication with the outdoor heat exchanger and the indoor heat exchanger to circulate a refrigerant between the outdoor heat exchanger and the indoor heat exchanger. The air conditioner unit further includes a circuit in electrical communication with the compressor and a controller. The controller is configured to determine a status of the circuit and permit or prevent activation of the compressor in response to the determined status of the circuit.

In yet another exemplary aspect of the present disclosure, a method of operating an air conditioner unit for a recreational vehicle is provided. The air conditioner unit includes a housing defining an indoor portion in fluid communication with an interior space and an outdoor portion with an outdoor heat exchanger and an outdoor fan disposed in the outdoor portion and an indoor heat exchanger and an indoor fan disposed in the indoor portion. The method includes receiving, by a controller of the air conditioner unit, a request to activate a compressor of the air conditioner unit. The method also includes determining, by the controller, a status of a circuit coupled to the controller and permitting or preventing activation of the compressor in response to the request to activate the compressor based on the determined status of the circuit. The compressor is in fluid communication with the outdoor heat exchanger and the indoor heat exchanger, such that activating the compressor causes the compressor to circulate a refrigerant between the outdoor heat exchanger and the indoor heat exchanger.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a recreational vehicle according to one or more exemplary embodiments of the present disclosure.

FIG. 2 provides a perspective view of a recreational vehicle air conditioner (RVAC) that may be used with the exemplary recreational vehicle of FIG. 1, with an outdoor cover removed for clarity.

FIG. 3 provides a perspective view of the exemplary RVAC of FIG. 2 with an indoor cover removed for clarity.

FIG. 4 provides a schematic view of an air conditioner unit according to one or more exemplary embodiments of the present disclosure.

FIG. 5 provides a schematic view of control elements which may be used with an air conditioner unit such as the exemplary air conditioner unit of FIG. 2 according to one or more exemplary embodiments of the present subject matter.

FIG. 6 provides a flow diagram of an exemplary method of operating an air conditioner unit such as the exemplary air conditioner unit of FIG. 2 according to one or more exemplary embodiments of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In order to aid understanding of this disclosure, several terms are defined below. The defined terms are understood to have meanings commonly recognized by persons of ordinary skill in the arts relevant to the present invention. The terms “includes” and “including” are intended to be inclusive in a manner similar to the term “comprising.” Similarly, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components. In addition, as used herein, terms of approximation, such as “approximately,” “substantially,” or “about,” refer to being within a ten percent margin of error. When used in the context of an angle or direction, such terms include within ten degrees greater or less than the stated angle or direction. For example, “generally vertical” includes directions within ten degrees of vertical in any direction, e.g., clockwise or counterclockwise.

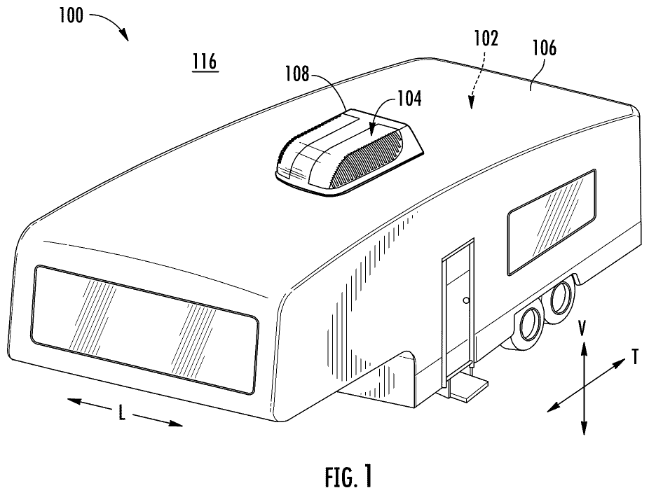

FIG. 1 provides a perspective view of an exemplary recreational vehicle 100 in accordance with the present disclosure. As may be seen in FIG. 1, the recreational vehicle 100 generally defines a vertical direction V, a lateral direction L, and a transverse direction T, each of which is mutually perpendicular, such that an orthogonal coordinate system is generally defined. People may employ recreational vehicle 100 for a variety of purposes, including transportation, cooking, eating, sleeping, entertaining, and the like. As such, recreational vehicle 100 defines a passenger compartment 102, which may further include a bed, stove, table, restroom, or multiple compartments for storing items that passengers wish to take with them on their travels. Because people often spend significant time within the passenger compartment 102 of recreational vehicle 100, climate control of the passenger compartment 102 is desirable.

Accordingly, an air conditioning system or air conditioner unit 104 may be mounted on recreational vehicle 100 to provide cooled air to the passenger compartment 102. Air conditioner unit 104 is typically mounted to an outside surface 106 of recreational vehicle 100. This arrangement is desirable because a byproduct of operation of air conditioner unit 104 is heated air, which has been passed over a heat exchanger to remove heat from the air circulating within passenger compartment 102. During certain operations, this heated air may be exhausted to the ambient air. As shown in the exemplary embodiment of FIG. 1, air conditioner unit 104 may be mounted on an outer surface 106, such as the top of recreational vehicle 100. Also as shown in FIG. 1, air conditioner unit 104 may include a top cover (outdoor cover) or outer grille 108 that is positioned over the working components of air conditioner unit 104, e.g., to protect such working components from rain, wind, debris, etc. Although an exemplary recreational vehicle is illustrated, it should be appreciated that air conditioner 104 may be used in or with any suitable recreational vehicle.

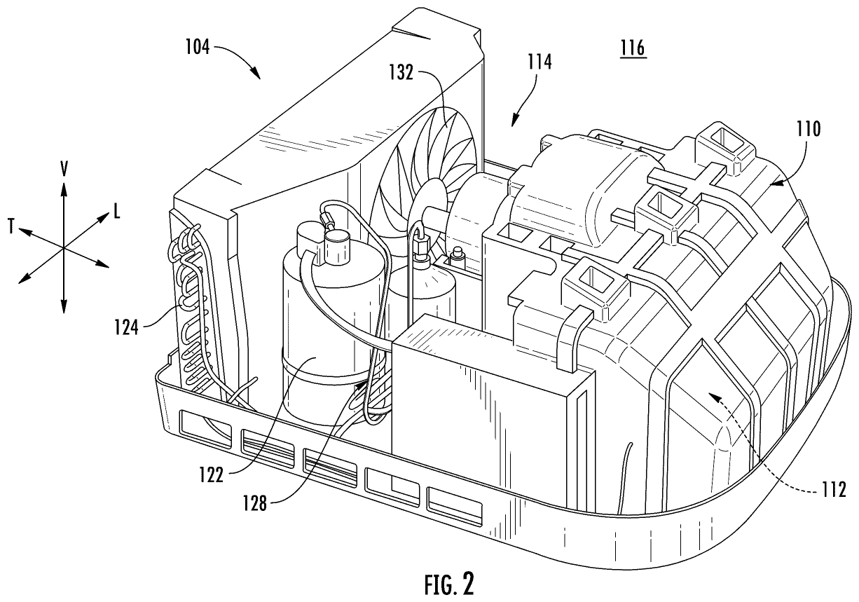

Referring now generally to FIGS. 2 through 4, the operation of air conditioner unit 104 will be described in more detail according to exemplary embodiments of the present subject matter. In this regard, FIG. 2 illustrates a top, perspective view of air conditioner 104 of recreational vehicle 100 with outer grille 108 removed to reveal internal working components of air conditioner 104. As illustrated, air conditioner unit 104 generally includes an indoor bulkhead or indoor cover 110 that divides air conditioner unit 104 between an indoor portion and an outdoor portion, such as in a packaged terminal air conditioner unit (PTAC) or a split heat pump system. Specifically, indoor cover 110 defines an indoor air plenum 112 and an outdoor air plenum 114. In this regard, indoor cover 110 generally shields the indoor components of air conditioner unit 104 from the outdoor environment 116.

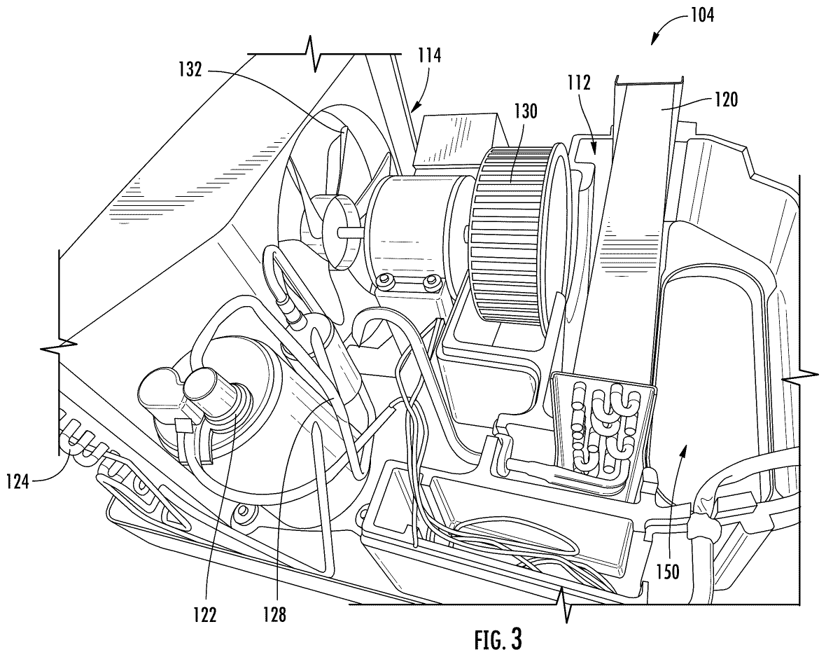

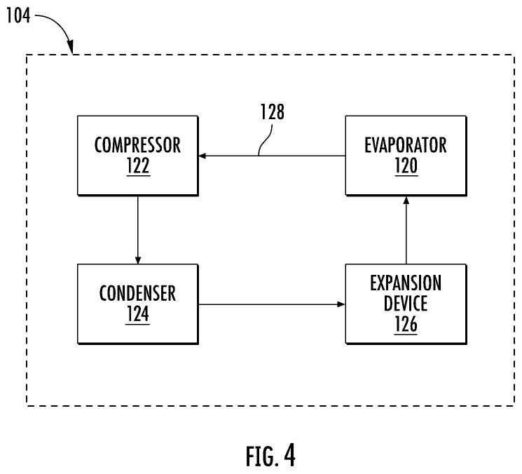

Referring now also to FIG. 3, indoor cover 110 is removed to reveal additional working components of air conditioner unit 104. In addition, FIG. 4 illustrates a schematic view of air conditioner unit 104. Relevant components of air conditioner unit 104 will now be described. It should be understood that air conditioner unit 104 includes various heat pump components, such as a sealed system, for treating air within an interior of an associated recreational vehicle 100. Such components are well understood by those skilled in the art and a description of such components is omitted for the sake of brevity.

In this regard, for example, air conditioner unit 104 includes refrigerant circulating between evaporator 120, compressor 122, condenser 124, and expansion device 126, as shown in the refrigeration loop 128 of air conditioner unit 104 in FIGS. 2 through 4. Refrigerant, also known as coolant, carries heat from the passenger compartment 102 of recreational vehicle 100 to the outdoors 116 (e.g., ambient area surrounding outer surface 106 of the passenger compartment 102). Refrigerant is useful because it changes states from a liquid to a vapor at convenient temperatures for a refrigeration cycle. One suitable refrigerant for use in refrigeration loop 128 is 1,1,1,2-Tetrafluoroethane, also known as R-134A, although it should be understood that the present disclosure is not limited to such example and that any suitable refrigerant may be utilized. For example, according to an exemplary embodiment, the refrigerant may be R-410A or another refrigerant.

The refrigerant begins by passing through evaporator 120 in liquid form. Ambient air or air from the passenger compartment 102 may pass over evaporator 120, e.g., as motivated by an evaporator air handler. More specifically, as illustrated, air conditioner unit 104 may include an indoor fan 130, such as a blower fan 130 as illustrated in FIG. 3, configured for urging a flow of indoor air. Because the liquid refrigerant is cold in this low-pressure state, it absorbs heat from the air passed over it, cooling the air for delivery to the passenger compartment 102. As the liquid refrigerant absorbs heat, it evaporates into a vapor. From there, the gaseous refrigerant is delivered to compressor 122, which increases the pressure of the refrigerant, thus raising its temperature well above the ambient temperature outside of recreational vehicle 100. From compressor 122, the heated refrigerant is delivered to condenser 124. Air may pass over condenser 124, e.g., as motivated from a condenser air handler. More specifically, as illustrated, air conditioner unit 104 may include an outdoor fan 132 configured for urging a flow of outdoor air, thereby facilitating heat transfer from the heated refrigerant to the ambient air. In releasing this heat energy, the refrigerant condenses back into liquid form. Next, the refrigerant is delivered to expansion device 126, where the pressure of the refrigerant is reduced, thus decreasing its temperature. The cooled, liquid refrigerant is then delivered back to evaporator 120 to repeat the process.

In some embodiments, the air conditioner unit 104 may provide a cooling capacity of about twelve thousand British Thermal Units (BTU) per hour (12 kBTU/hr) or more, such as about 13.5 kBTU/hr or more, such as about 15 kBTU/hr or more, such as about 18 kBTU/hr. Also, the air conditioner unit 104 may provide an air flow rate within the passenger compartment of about one hundred cubic feet per minute (CFM) or more, such as about 150 CFM or more, such as about 200 CFM or more, such as about 300 CFM. The air conditioner unit 104 may be configured to and/or operable to provide such cooling and/or air flow rates at least in part by the size and location of the indoor fan 130. As mentioned above and as shown in FIG. 3, the indoor fan 130 may be a blower fan. In particular, the blower fan 130 may include a six inch (6″) or larger blower wheel, such as an eight inch (8″) or larger blower wheel, such as a ten inch (10″) or larger blower wheel. The blower wheel may be positioned directly above the opening 136.

In some embodiments, air conditioner unit 104, e.g., the sealed system thereof, may be selectively operated as a refrigeration assembly (and thus perform a refrigeration cycle, e.g., as described above) or a heat pump (and thus perform a heat pump cycle). Thus, as is understood, exemplary embodiments of air conditioner unit 104 may be selectively operated perform a refrigeration cycle at certain instances (e.g., while in a cooling mode) and a heat pump cycle at other instances (e.g., while in a heating mode), such as by positioning a reversing valve to direct high pressure and high temperature vapor refrigerant from the compressor to outdoor heat exchanger (ostensibly the “condenser” 124, although it is understood that condenser 124 would operate as the evaporator in heat pump mode) or the indoor heat exchanger (ostensibly the “evaporator” 120, although it is understood that evaporator 120 would operate as the condenser in heat pump mode) according to the selected mode.

The reversing valve may be, for example, a four-way valve. The reversing valve reverses the flow direction of refrigerant from the compressor 122 (e.g., to the opposite of the flow in the refrigeration cycle described above). For example, in cooling mode, the reversing valve is arranged or configured to direct compressed, e.g., high-pressure, vapor refrigerant from compressor 122 to condenser 124, whereupon the vapor-phase refrigerant releases heat to the air flowing over or around the condenser 124 and condenses to a liquid phase, e.g., as described above. Conversely, in heating mode, the reversing valve is arranged or configured to direct the compressed, e.g., high-pressure, vapor refrigerant from compressor 126 to the evaporator 120, whereupon the ostensible evaporator 120 acts as the condenser in heat pump mode or heating mode. Thus, the reversing valve permits air conditioner unit 104 to adjust between the heating mode and the cooling mode.

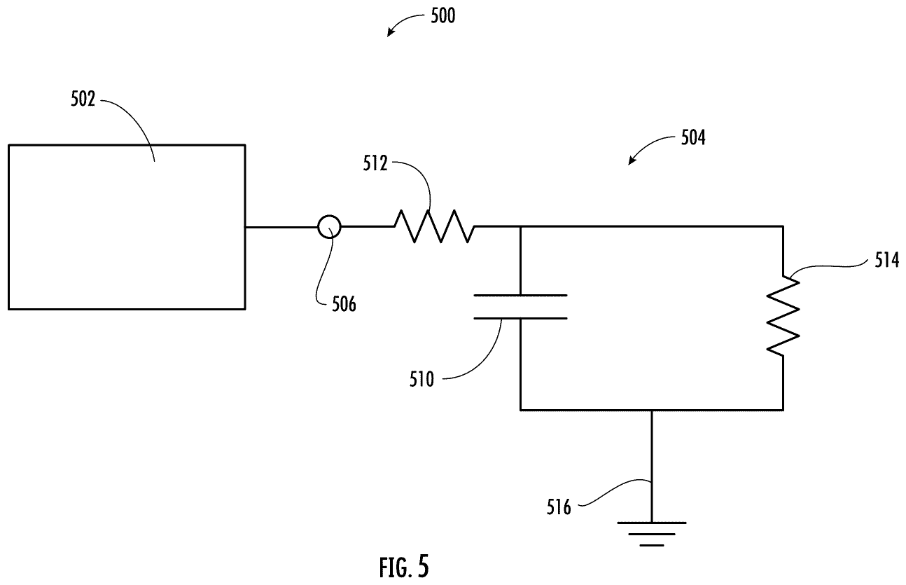

FIG. 5 provides a schematic view of a control system 500 comprising a controller 502 and a circuit 504. The controller 502 and circuit 504 are coupled via a switching device 506. The switching device 506 may be any suitable electrical switching device, such as a switch, a gate, a Metal-Oxide-Semiconductor Field-Effect Transistor (MOSFET), or the like, including combinations of one or more of the preceding devices. As will be described in more detail below, the control system 500 may be configured to provide a soft start to the compressor 122, e.g., to provide at least a minimum OFF time of the compressor 122 before restarting the compressor 122. In particular, the circuit 504 may be a timer circuit, such as a charge on one or more energy storage devices of the circuit 504 may correspond to the minimum OFF time, and the charge (e.g., voltage) on the one or more energy storage devices may be read by the controller 502 before permitting the compressor 122 to be activated.

In some embodiments, the control system 500 may be a soft start system, e.g., the controller 502 may be a dedicated soft start controller (e.g., microcontroller) which is separate from and in addition to a main controller of the air conditioner unit, and which is configured to allow a minimum OFF time between operating cycles of the air conditioner unit 104, e.g., the compressor 122 thereof, to elapse. In additional embodiments, the controller 502 may be incorporated in the main controller of the air conditioner unit 104 to provide the soft start features.

The controller 502 may be or may include a processing device that may be generally configured to facilitate operation of the air conditioner unit 104. For example, signals generated by controller 502 may operate the air conditioner unit 104, including any or all system components, subsystems, or interconnected devices, in response to, e.g., user inputs or selections and other control commands received from one or more user input devices. Components of air conditioner unit 104 may be in communication with controller 502 via, for example, one or more signal lines or shared communication busses. In this manner, Input/Output (“I/O”) signals may be routed between controller 502 and various operational components of air conditioner unit 104.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 502 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 502 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 502 may be operable to execute programming instructions or micro-control code associated with an operating cycle of air conditioner unit 104. In this regard, the instructions may be software or any set of instructions that when executed by the processing device, cause the processing device to perform operations, such as running one or more software applications, displaying a user interface, receiving user input, processing user input, etc. Moreover, it should be noted that controller 502 as disclosed herein is capable of and may be operable to perform any methods, method steps, or portions of methods as disclosed herein. For example, in some embodiments, methods disclosed herein may be embodied in programming instructions stored in the memory and executed by controller 502.

The memory devices may also store data that can be retrieved, manipulated, created, or stored by the one or more processors or portions of controller 502. The data can include, for instance, data to facilitate performance of methods described herein. The data can be stored locally (e.g., on controller 502) in one or more databases and/or may be split up so that the data is stored in multiple locations. In addition, or alternatively, the one or more database(s) can be connected to controller 502 through any suitable network(s), such as through a high bandwidth local area network (LAN) or wide area network (WAN). In this regard, for example, controller 502 may further include a communication module or interface that may be used to communicate with one or more other component(s) of air conditioner unit 104, controller 502, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

The circuit 504 may generally include an energy storage device and an energy dissipation device. The circuit 504 may thus provide a soft start, e.g., where the energy storage device accumulates energy such as an electrical charge during operation of the compressor 122 and, beginning when the compressor is deactivated, such energy is depleted at a known rate through the energy dissipation device to thereby track the OFF time of the compressor 122. In various exemplary embodiments, the energy storage device may be, e.g., a battery and the energy dissipation device may be, e.g., a light such as an LED. As another example, the circuit 504 may be a resistor-capacitor (RC) circuit (e.g., may include one or more resistors, e.g., resistor 514, and at least one capacitor 510), where the capacitor(s) represent an embodiment of the energy storage device and the resistor(s) represent an embodiments of the energy dissipation device. The circuit 504 may be in electrical communication with the compressor 122, such as indirectly connected to the compressor 122, such as the circuit 504 may be wired to a control circuit which supplies electrical power to the compressor 122 whereby the at least one capacitor 510 (or battery or other energy storage device) is charged while the compressor 122 is activated or operating (e.g., when the switching device 506 is in a corresponding position or configuration to permit the flow of electrical current through the circuit 504 while electrical power is supplied to the compressor). For example, the circuit 504 may include a charge resistor 512 through which electrical current flows while charging the capacitor 510.

When the compressor 122 is shut off (deactivated) the charge on the capacitor 510 may drain through resistor 514, e.g., resistor 514 may be a drain resistor, or through another energy dissipation device). Additionally, as illustrated in FIG. 5, the circuit 504 may include or be connected to a ground 516. The resistor 514 and the capacitor 510 may be selected to provide a defined drain time for the capacitor 510 (from a fully-charged state). The defined drain time may be equal to or greater than a minimum down time or OFF time for the compressor 122.

As mentioned, the controller 502 may be connected to the circuit 504 via a switching device 506. For example, the switching device 506 may be configured to prevent the capacitor 510 from draining or discharging to the controller 502 when the compressor is deactivated, e.g., when the switching device 506 is in a first position or first configuration, electrical communication from the capacitor 510 to the controller 502 may be limited or obstructed by the switching device 506. In order to read the charge (voltage) on the capacitor 510, the controller 502 may actuate the switching device 506 from the first position or first configuration to a second position or second configuration, where electrical communication between the controller 502 and the capacitor 510 may be permitted via the switching device. Thus, the controller 502 may determine a status of the circuit 504, e.g., a charge on one or more capacitors thereof, when the switching device 506 is in the second position or second configuration. The charge on the one or more capacitors may be compared to a full charge on the one or more capacitors, and the proportion of the determined charge to the full charge may correspond to the down time of the compressor.

Based on the determined status of the circuit, the controller 502 may permit or prevent activation of the compressor. For example, where the status of the circuit is a charge on the capacitor 510 (and/or one or more additional capacitors which may be included in the RC circuit) the controller 502 may be configured to permit activation of the compressor when the charge on the capacitor is equal to or less than a voltage threshold. As mentioned above, the resistor 514 (or other energy dissipation device) and the capacitor 510 (or other energy storage device) may be selected to provide a defined drain time for the capacitor 510. Thus, when the compressor is shut off, electrical charge may begin to drain from the capacitor 510, and the remaining charge on the capacitor may thus be proportional to or otherwise correspond to the amount of down time (off time) for the compressor. Accordingly, in some embodiments, the defined drain time may be equal to the minimum down time or OFF time for the compressor 122, and the voltage threshold may be zero. In additional embodiments, the defined drain time may be greater than the minimum down time or OFF time for the compressor 122, and the voltage threshold may thusly be greater than zero. For example, in embodiments where the voltage threshold is greater than zero, the controller 502 may be configured to read the voltage on the capacitor, look up the read voltage in a lookup table (e.g., which the controller may access from a local memory which is part of the controller or otherwise incorporated into the air conditioner unit or from a remote memory, e.g., over the internet), and determine an off time of the compressor which is correlated to the remaining charge on the capacitor in the lookup table. Thus, when the determined off time from the lookup table is greater than or equal to the minimum off time, the controller may permit activation of the compressor, or, when the determined off time from the lookup table is less than the minimum off time, the controller 502 may prevent activation of the compressor. For example, the minimum off time may be about three minutes. In such embodiments, the defined drain time may be three minutes and the voltage threshold may be zero. In additional embodiments where the minimum off time is three minutes, the defined drain time may be more than the minimum off time and the voltage threshold may be greater than zero, such as the defined drain time may be about four minutes, and the voltage threshold may be about 25% of the full charge of the capacitor.

As noted above, features illustrated or described as part of one embodiment can be used with another embodiment to yield a still further embodiment, and it is intended that the present invention covers such modifications and variations as come within the scope of the appended claims and their equivalents. In one example of such variation within the scope of the present disclosure, the energy storage device may be a battery in combination with a resistor as the energy dissipation device, or the energy dissipation device may be an LED in combination with a capacitor as the energy storage device, among other possible variations and combinations. Also by way of example, different types of devices may be used together, such as the energy dissipation device may include a combination of LEDs and resistors, and/or the energy storage device may include a combination of one or more batteries with one or more capacitors.

Now that the construction of an air conditioner unit 104 and the configuration of controller 502 according to exemplary embodiments have been presented, exemplary methods of operating an air conditioner unit will be described. In exemplary embodiments, the various method steps as disclosed herein may be performed by controller 502 or a separate, dedicated controller. Furthermore, some or all of the various method steps may be performed remotely, e.g., in a distributed computing environment such as the cloud, fog, or edge, wherein the controller 502 communicates with one or more remote computing devices of the distributed computing environment, such as processing may be performed in the cloud and the output of such process may be transmitted to and received by the an air conditioner unit, such as by the controller thereof.

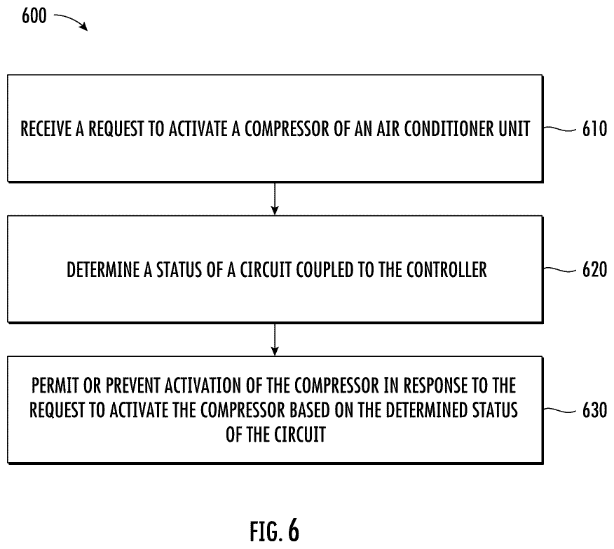

An exemplary method 600 of operating an air conditioner unit is illustrated in FIG. 6. The air conditioner unit may, for example, be configured for use in, and/or incorporated into, a recreational vehicle. For example, the air conditioner unit may include a housing defining an indoor portion and an outdoor portion. The indoor portion may be in fluid communication with an interior space (e.g., the passenger compartment within the RV). An outdoor heat exchanger and an outdoor fan may be disposed in the outdoor portion, and an indoor heat exchanger and an indoor fan may be disposed in the indoor portion.

FIG. 6 provides a flow diagram of an example method 600 of operating an air conditioner unit according to an example embodiment of the present subject matter. For instance, an air conditioner unit 104 described herein can be utilized to implement method 600. In this regard, for example, a controller of the an air conditioner unit may be configured for implementing some or all steps of one or more of the following exemplary methods. Accordingly, to provide context to method 600, the numerals used above to denote various features of air conditioner unit 104 will be utilized below. The example method 600 described below provides one example manner in which an air conditioner unit can be operated, however, the description below is provided only to describe exemplary aspects of the present subject matter, and is not intended to be limiting.

As shown in FIG. 6, method 600 may include (610) receiving a request to activate a compressor of the air conditioner unit. The request may be received by a controller of the air conditioner unit. For example, the request may be initiated in response to a user input, such as an “on” input for the air conditioner unit, a temperature setting, or other similar user input.

Method 600 may also include (620) determining, a status of a circuit coupled to the controller, e.g., the controller may be programmed or otherwise configured to determine the status of the circuit. For example, the circuit may be or may include a resistor-capacitor circuit including a resistor and one or more capacitors. In such embodiments, determining the status of the circuit may include determining a charge on the one or more capacitors, e.g., as described above, the circuit may be designed and selected such that a defined drain time is provided, and the defined drain time may be approximately equal to the minimum off time or greater than the minimum off time. Thus, for example, permitting or preventing activation of the compressor in response to the determined charge on the one or more capacitors may include permitting activation of the compressor in response to the charge on the one or more capacitors less than a threshold voltage and preventing activation of the compressor in response to the charge on the one or more capacitors greater than the threshold voltage. For example, as described above, the threshold voltage may be zero when the defined drain time is approximately equal to the minimum off time, or the threshold voltage may be greater than zero when the defined drain time is greater than the minimum off time, and the threshold voltage may be proportional to the minimum off time, such as the threshold voltage may be based on a proportion of the minimum off time to the defined drain time.

Method 600 may further include (630) permitting or preventing activation of the compressor in response to the request to activate the compressor based on the determined status of the circuit. The compressor is in fluid communication with the outdoor heat exchanger and the indoor heat exchanger such that activating the compressor causes the compressor to circulate a refrigerant between the outdoor heat exchanger and the indoor heat exchanger (e.g., when activation is permitted, such as when the determined status of the circuit indicates that the minimum off time has elapsed and therefore a soft start is possible).

For example, methods of operating the air conditioner unit may include multiple operating cycles and ensuring that the minimum off time has elapsed between the multiple operating cycles. In some embodiments, methods of operating an air conditioner unit may include, prior to receiving the request to activate the compressor, operating the compressor in a previous cycle, and deactivating the compressor after the previous cycle and before receiving the request to activate the compressor. Thus, the request to activate the compressor (e.g., at 610) may be a request to initiate a new cycle or current cycle of the air conditioner unit after the previous cycle (e.g., after the previous cycle has ended and the compressor deactivated), and the soft start features may prevent starting the new cycle before the minimum off time has elapsed (e.g., where the minimum off time is the time for the pressure to equalize or become approximately equal across the compressor). For example, the RC circuit may provide a timer circuit for the soft start systems and methods. Methods of operating an air conditioner unit according to the present disclosure may therefore include charging the one or more capacitors while operating the compressor during the previous cycle. When the compressor is deactivated, the one or more capacitors thus begin to drain, and the amount of remaining charge on the one or more capacitors thereby reflects the amount of off time since the compressor was deactivated at the end of the previous cycle. Thus, activation of the compressor in response to the request, e.g., to initiate the new or current cycle, may be permitted or prevented based on the determined status of the circuit, e.g., charge on the one or more capacitors.

Soft start systems and methods according to the present disclosure may provide numerous advantages. For example, and without limitation, aspects of the present disclosure may advantageously provide soft start without excessive delay (e.g., in contrast to systems and methods which impose a fixed delay time when the compressor is to be activated).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A recreational vehicle that defines a passenger compartment therein, the recreational vehicle comprising:
an air conditioner unit, the air conditioner unit comprising:
a housing defining an indoor portion in fluid communication with the passenger compartment and an outdoor portion;
an outdoor heat exchanger and an outdoor fan disposed in the outdoor portion;
an indoor heat exchanger and an indoor fan disposed in the indoor portion;
a compressor in fluid communication with the outdoor heat exchanger and the indoor heat exchanger to circulate a refrigerant between the outdoor heat exchanger and the indoor heat exchanger;
a circuit in electrical communication with the compressor; and
a controller coupled to the circuit, the controller configured to determine a status of the circuit and permit or prevent activation of the compressor in response to the determined status of the circuit.

2. The recreational vehicle of claim 1, wherein the circuit comprises an energy storage device and an energy dissipation device.

3. The recreational vehicle of claim 2, wherein the circuit comprises a resistor-capacitor circuit, wherein the energy dissipation device comprises a resistor and the energy storage device comprises one or more capacitors.

4. The recreational vehicle of claim 2, wherein the status of the circuit is a charge on the energy storage device.

5. The recreational vehicle of claim 4, wherein the controller is configured to permit activation of the compressor in response to the charge on the energy storage device less than a threshold voltage and to prevent activation of the compressor in response to the charge on the energy storage device greater than the threshold voltage.

6. The recreational vehicle of claim 5, wherein the threshold voltage is greater than zero.

7. The recreational vehicle of claim 2, wherein the circuit is in electrical communication with a power supply, whereby the energy storage device is charged while the compressor is activated.

8. The recreational vehicle of claim 7, wherein the circuit is configured to discharge the energy storage device while the compressor is deactivated.

9. The recreational vehicle of claim 1, wherein the controller is coupled to the circuit via a switching device, wherein the controller is configured to actuate the switching device and determine the status of the circuit after actuating the switching device.

10. An air conditioner unit for a recreational vehicle, the air conditioner unit comprising:
a housing defining an indoor portion in fluid communication with an interior space and an outdoor portion;
an outdoor heat exchanger and an outdoor fan disposed in the outdoor portion;
an indoor heat exchanger and an indoor fan disposed in the indoor portion;
a compressor in fluid communication with the outdoor heat exchanger and the indoor heat exchanger to circulate a refrigerant between the outdoor heat exchanger and the indoor heat exchanger;
a circuit in electrical communication with the compressor; and
a controller coupled to the circuit, the controller configured to determine a status of the circuit and permit or prevent activation of the compressor in response to the determined status of the circuit.

11. The air conditioner unit of claim 10, wherein the circuit comprises an energy storage device and an energy dissipation device.

12. The air conditioner unit of claim 11, wherein the circuit comprises a resistor-capacitor circuit wherein the energy dissipation device comprises a resistor and the energy storage device comprises one or more capacitors.

13. The air conditioner unit of claim 11, wherein the status of the circuit is a charge on the energy storage device.

14. The air conditioner unit of claim 13, wherein the controller is configured to permit activation of the compressor in response to the charge on the energy storage device less than a threshold voltage and to prevent activation of the compressor in response to the charge on the energy storage device greater than the threshold voltage.

15. The air conditioner unit of claim 14, wherein the threshold voltage is greater than zero.

16. The air conditioner unit of claim 11, wherein the circuit is in electrical communication with a power supply, whereby the energy storage device is charged while the compressor is activated.

17. The air conditioner unit of claim 16, wherein the circuit is configured to discharge the energy storage device while the compressor is deactivated.

18. The air conditioner unit of claim 10, wherein the controller is coupled to the circuit via a switching device, wherein the controller is configured to actuate the switching device and determine the status of the circuit after actuating the switching device.

19. A method of operating an air conditioner unit for a recreational vehicle, the air conditioner unit comprising a housing defining an indoor portion in fluid communication with an interior space and an outdoor portion with an outdoor heat exchanger and an outdoor fan disposed in the outdoor portion and an indoor heat exchanger and an indoor fan disposed in the indoor portion, the method comprising:
receiving, by a controller of the air conditioner unit, a request to activate a compressor of the air conditioner unit;
determining, by the controller, a status of a circuit coupled to the controller; and
permitting or preventing activation of the compressor in response to the request to activate the compressor based on the determined status of the circuit, wherein the compressor is in fluid communication with the outdoor heat exchanger and the indoor heat exchanger, whereby activating the compressor causes the compressor to circulate a refrigerant between the outdoor heat exchanger and the indoor heat exchanger.

20. The method of claim 17, wherein the circuit comprises an energy storage device and an energy dissipation device and wherein determining the status of the circuit comprises determining a charge on the energy storage device, wherein permitting or preventing activation of the compressor in response to the determined charge on the energy storage device comprises permitting activation of the compressor in response to the charge on the energy storage device less than a threshold voltage and preventing activation of the compressor in response to the charge on the energy storage device greater than the threshold voltage, further comprising, prior to receiving the request to activate the compressor, operating the compressor in a previous cycle, charging the energy storage device while operating the compressor during the previous cycle, and deactivating the compressor after the previous cycle and before receiving the request to activate the compressor.
